(19) United States
(12) Patent Application Publication
(10) Pub. No.: US 2015/0215253 A1
(43) Pub. Date: Jul. 30, 2015

(54) SYSTEM AND METHOD FOR AUTOMATICALLY MINING CORPUS OF COMMUNICATIONS AND IDENTIFYING MESSAGES OR PHRASES THAT REQUIRE THE RECIPIENT'S ATTENTION, RESPONSE, OR ACTION

(71) Applicants: Sunil Vemuri, Santa Clara, CA (US); Giridhar Bandi, HYDERABAD (IN); Steven Paul Ketchpel, Foster City, CA (US)

(72) Inventors: Sunil Vemuri, Santa Clara, CA (US); Giridhar Bandi, HYDERABAD (IN); Steven Paul Ketchpel, Foster City, CA (US)

(21) Appl. No.: 14/607,086

(22) Filed: Jan. 28, 2015

(30) Foreign Application Priority Data
Jan. 29, 2014 (IN) 401/CHE/2014

(51) Int. Cl. H04L 12/58; G06N 99/00; G06F 17/24

(52) U.S. Cl. CPC H04L 51/12; H04L 51/02; G06F 17/248; G06N 99/005

(57) ABSTRACT

Exemplary embodiments of the present disclosure are directed towards a system for processing communications that detects just the portions of the communication requesting action, a response, or increased attention from a user, wherein said system comprises: (a) a message filter unit that analyzes the content and metadata of messages conveyed by various communication modalities and determines which portions of the messages request action, a response, or increased attention from the user; (b) a sender importance unit that determines from past communication patterns the perceived urgency that the user will afford to a new message from a particular sender; and (C) a user interface unit that alerts the user to detected items that require attention, response or action. Additionally, the disclosure describes a method for managing a list of tasks requiring attention automatically, where incoming messages are scanned and action items extracted and added to the list.

### TECHNICAL FIELD

The subject matter generally relates to a system and method for automatically mining corpora of communications and identifying messages or phrases that require the recipient's attention, response or action.

### BACKGROUND

In general, a user device operating in a data communication network is configured with various communication modalities (e.g., SMS applications, Email applications, Social Networking applications, Calendar applications, and other applications). The user device is bombarded with multiple messages across these communication modalities. Some of these messages may require a user's prompt attention, some may not need prompt attention, and some may not require any attention. Determining the importance of received messages and identifying the messages that require user attention is difficult. It is desirable to determine the importance of the received messages and notify the user of important messages.

Furthermore many messages, such as marketing and promotional messages, associated with the aforementioned communication modalities try to assume familiarity and demand responses from the user in a way confusingly close to legitimate requests for expertise and attention.

Therefore, it is desirable to have a system and method that ascertains the necessity of requesting user attention, and tracks and prioritizes the messages requiring user attention and user response.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present invention and the scope thereof can be obtained from the accompanying drawings that are briefly summarized below and the following detailed description of the presently preferred embodiments.

Exemplary embodiments of the present disclosure are directed towards a system and method for automatically mining corpora of communications and identifying messages or phrases that require the recipient's attention, response or action.

According to one or more exemplary embodiments, the method for automatically mining a corpus of communications and identifying critical messages may be performed locally with a data-communication-device-based approach, performed centrally with a server-unit-based approach or may be configured to operate between one or more data communication devices, with a client-server architecture wherein the client device may be any data communication device operated in a data communication network (e.g., a server, client device, or even a router).

A preferred aspect of the present disclosure is to automatically review a user's incoming corpus of communications and extract those communications that require a response, extra attention, or follow up of action from the user.

A preferred aspect of the present disclosure is to mine data from multiple communication modalities such as email, SMS, instant messaging, social networking applications sites such as Facebook and Twitter, phone voice mail communications, audio and video streams and other similar modalities configured in the data communication device.

Another preferred aspect of the present disclosure is to split the extracted data from each communication modality into multiple phrases.

A preferred aspect of the present disclosure is to base the system on classification algorithms that extract features from message content, message metadata, the user's contact list and communication history. In one embodiment, the classification algorithm is a supervised machine-learning algorithm that may use, but is not limited to, the Bayesian combination of probabilities.

Also another preferred aspect of the present disclosure is to highlight the corresponding processed phrases that do contain an actionable item, a question requiring response, or message needing extra attention over the user interface of the data communication device of the user.

Another preferred aspect of the present disclosure is to use exemplar-based, nearest-neighbor based on the cosine distance between vectors representing phrases and prototypical examples.

Also, another preferred aspect of the present disclosure is to include message content features such as (without limitation) n-grams of consecutive words, and the presence and position of key words (e.g., “please” or “ASAP”).

A preferred aspect of the present disclosure is to include message metadata features such as (without limitation) message length, time and date of sending, headers included from delivery services (e.g., spam-filter ratings), number and identities of other recipients, whether the recipient is specifically named or included as part of a mailing list or whether the message was in response to a previous message.

Another preferred aspect of the present disclosure is to include any or all of the user's contact lists, such as an email address book, social network contacts, phone numbers in mobile phone, users sharing a corporate email domain, contacts who have previously received mail from the user, or the transitive closure (whether limited to a certain number of degrees or unlimited) of such trusted contacts.

Also another preferred aspect of the present disclosure is to include any or all of the user's communication history, such as past emails sent and received, past text messages sent and received, past phone calls placed or received, past social media posts or messages sent or received.

A preferred aspect of the present disclosure is to include steps to transform the phrase into a “canonical” form, which renders consistent forms such as consistent form of contractions and abbreviations, syntactic transformation to handle active/passive voice, syntactic transformation to handle prepositional movement at sentence end (for example “By when is the report due?”=>“When is the report due by?”), conflation of synonyms into an abstract conceptual representation, removal of words unlikely to bear on a message's need for action/response, including (without limitation): articles, adjectives, excerpts of previous messages forwarded by the sender, directly quoted passages, headers or other materials, social niceties and abstraction of the specific identity of proper nouns, dates or times, places, or numbers.

Another preferred aspect of the present disclosure is to present the extracted action items in convenient form and a convenient time by a user.

Another preferred aspect of the present disclosure is to include presentation such as visual highlighting of extracted action item(s), audio summary of extracted action item(s) and entry of extracted action item onto the user's “Tasks Requiring Attention”.

Another preferred aspect of the present disclosure is to present notifications to the user based on the context of the user, including, without limitation, information derived from the user's calendars and sensors such as those in a vehicle, residence, communication device or wearable device. Such sensors could beneficially provide the user's current location and the speed at which the user is travelling, among other quantities.

Also another preferred aspect of the present disclosure is to present the user with assistance to reply/handle the extracted action item.

Further, another preferred aspect of the present disclosure is to provide the user with canned responses that offer a quick response that syntactically matches the form of the question or mention when a real response can be expected.

Still another preferred aspect of the present disclosure is to analyze templates or past responses from the user that are relevant to the request, and then present them for sending or editing.

Also a preferred aspect of the present disclosure is to track the completion status of requests extracted from incoming messages. The system also adds extracted items to a representation of tasks requiring attention; such representation may be a “Tasks Requiring Attention” list. The system also controls the presentation of this list and the removal of items from it.

Another preferred aspect of the present disclosure is to remove items from the representation of tasks requiring attention when the user replies to the corresponding message.

Also, another preferred aspect of the present disclosure is to enable the removal of items from the representation of tasks requiring attention only if the content of message appears to be a resolution (and not, for example, a request for more time).

Still another preferred aspect of the present disclosure is to remove items from the representation of tasks requiring attention when the system does not receive responses regarding those items for a certain amount of time.

Yet another preferred aspect of the present disclosure is to prioritize the order of presentation of action items by any or all of: importance of sender, stated urgency of request and time since request was received.

Another preferred aspect of the present disclosure is to manage the full cycle of communications that include action items: determining actionability by extracting relevant input features from metadata and content, transforming extracted content, assessing desired output features, alerting the user, supporting the user in completing the action item and supporting the user in tracking completion status/pending items.

System and method for processing communications that detects just the portions of the communication requesting action, a response, or increased attention from a user are disclosed. The system comprising a message filter unit that analyzes the content and metadata of messages conveyed by various communication modalities and determines which portions of the messages request action, a response, or increased attention from the user.

The system further includes a sender importance unit that determines from past communication patterns the perceived urgency that the user will afford to a new message from a particular sender.

The system further includes a user interface unit that alerts the user to detected items that require attention, response or action.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a block diagram depicting a system for automatically mining corpora of communications and identifying messages or phrases that require the recipient's attention, response, or action, in accordance with exemplary embodiments of the present disclosure.

FIG. 2 is a diagram depicting a filter module with sub filters for mining corpora of communications and identifying messages or phrases which require the recipient's attention, response, or action, in accordance with exemplary embodiments of the present disclosure.

FIG. 3 is a diagram depicting a system for displaying current notifications on the data communication device, in accordance with exemplary embodiments of the present disclosure.

FIG. 4 is a block diagram depicting a system for assisting a user in responding to or handling action items and tracking completion status, in accordance with exemplary embodiments of the present disclosure.

FIG. 5 is a flow diagram depicting a method for automatically mining corpora of communications and identifying actions, in accordance with exemplary embodiments of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

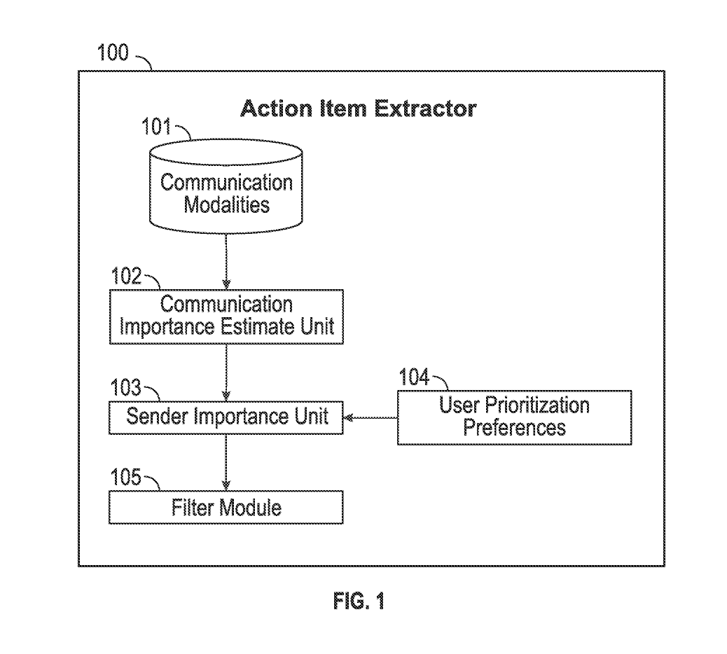

Referring to FIG. 1 is a diagram 100 depicting a system for automatically mining corpora of communications and identifying actions, in accordance with exemplary embodiments of the present disclosure. The diagram 100 includes various communication modalities 101, that may include, but are not limited to, social networking applications, a communication access unit (with the ability to read current and historical messages, email, call logs, voice mails, and mms), a contact list, a location history unit and the like.

The various communication modalities 101 may be used to identify the user specific contacts, creation date of contacts, recency of last contact, shared domain (which, if it is not a common email provider such as gmail, yahoo, hotmail, etc., may indicate a shared employer or academic institution), and shared last name. Features not available directly from the contact book but require extraction from the call logs may also be included, such as information relating to frequency and length of communication, along with time of first contact and most recent contact, and the like. These data items, collectively called the “metadata” associated with the messages, are inputs that help to evaluate the importance of the message or its sender.

As shown in FIG. 1, the system 100 includes a communication importance estimate unit 102 that may be configured to evaluate content associated with the corpora of communications retrieved from various communication modalities 101. Estimates of importance may be based on whether the message was responded to, how quickly, by how many recipients, and the amount of discussion that followed.

As shown in FIG. 1, the system 100 includes a sender importance unit 103 that may be configured to process the output received from the communication importance estimate unit 102 and infer the likely importance of each sender of existing messages, and transmit the results to a filter module 105. The sender importance unit 103 may be modified by user prioritization preferences 104, such preferences may reflect the times of day when a user is willing to handle work-related messages or people whose messages merit extra consideration, such as a family member. The filter module 105 may be used to filter the corpora of incoming communications, identifying those phrases or messages that require the recipient's attention, response or action.

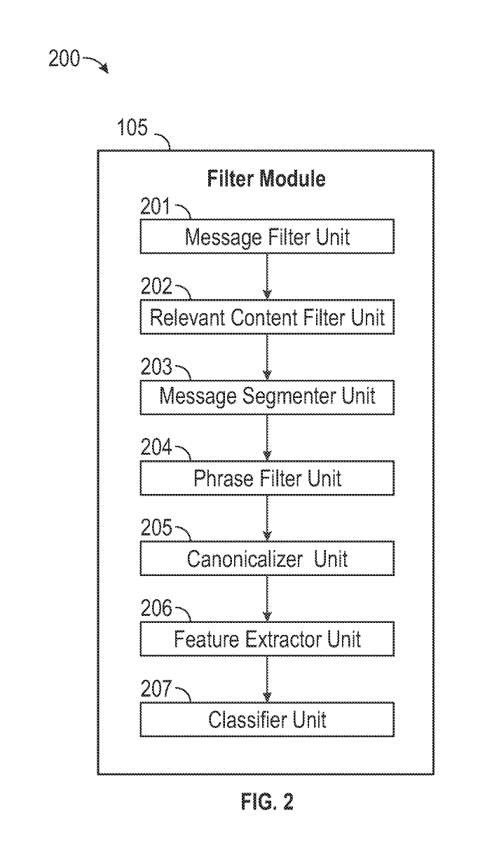

Referring to FIG. 2 is a diagram 200 depicting a filter module 105 (shown in FIG. 1) with sub filters for mining corpora of communications and identifying messages or phrases that require attention, a response, or action, in accordance with exemplary embodiments of the present disclosure. The filter module 105 may include a message filter 201, configured to filter the corpora of communications. Filtering the corpora of communications may include a step of excluding communications received from unknown senders and considering only the communications from known senders. For example, known senders may include, but are not limited to, the senders for whom previously a communication has been made through email or SMS, whose identity is listed in the “cc” field in any previous email sent or previously listed as a recipient of SMS, or whose identity is listed as a co-recipient with the user in an email or SMS. Further, the message filter unit 201 may exclude communications by identifying the sender as a promoter or marketer. Identifying the promoters may include a step of identifying if the communication has a different “reply-to” than “from” field, identifying keywords such as “do-not-reply” or “unsubscribe” in the sender's email address, identifying a known list server (e.g. MailChimp, Convio, ConstantContact, VerticalResponse, Flonetwork, or ExactTarget) in the return path of the sender's communication. The message filter 201 may also exclude communications containing a “List Unsubscribe” mail header or similar phrase (e.g., “If you cannot view” or “Click here to unsubscribe”)

As shown in FIG. 2, the filter module 105 may include a relevant content filter unit 202 that receives the corpora of communications from the message filter unit 201. The relevant content filter unit 202 may be configured to remove signatures associated with the communication, bypass excerpts of replies and forwarded communications contained within the communication and extract only the relevant content from the filtered content. The relevant content filter unit 202 may exclude signatures and/or footers associated with the content received from the message filter unit 201 by identifying keywords or phrases such as “If you have received this in error . . . ” or other data elements common to automatically appended signatures including the email address, phone number, job title, fax number, Twitter handle, etc. The relevant content filter unit 202 may also exclude messages sent by auto-responders, as determined by measuring the response time between message arrival and reply arrival and looking for keywords that are commonly found in “out-of-office” messages. The relevant content filter unit 202 also excludes headers that assist with mail delivery protocols and forwarded content, demarcated by phrases such as “Begin forwarded message” or other patterns commonly used to indicate included content, such as “>>” at the beginning of the line.

As shown in FIG. 2, the filter module 105 may include a message segmenter unit 203 configured to collect phrases of filtered content as received from the relevant content filter unit 202. The message segmenter unit 203 may be configured for converting and dividing the filtered content into multiple phrases such as sentences or other meaningful content units, without limiting the scope of the disclosure.

As shown in FIG. 2, the filter module 105 may include a phrase filter unit 204 configured for receiving the multiple phrases as defined by the message segmenter unit 203. The phrase filter unit 204 may be configured to filter the phrases defined by the message segmenter unit 203 to make a first pass at eliminating the content that does not require a user's response, attention, or action, while passing through phrases where the resolution is not easily determined and requires further analysis. The phrase filter unit 204 may be configured to include phrases that have potentially actionable words such as “please” or “send me” or “What time” or phrases that start with a verb (after removing an initial proper name and “please”, if either or both exist); exclude phrases that look like social niceties (e.g., “How are you?” or “How was your weekend?”); determine whether the phrase is too short or too long based on the word count and whether the phrase has too many capitalized words or is in ALL CAPS; exclude phrases that look like rhetorical questions (e.g., “How great is that?”).

As shown in FIG. 2, the filter module 105 may include a canonicalizer unit 205 configured for receiving the filtered phrases from the phrase filter unit 204 and converting variations of the same expressions of the filtered phrases into a single form. The canonicalizer unit 205 may be configured for removing stop words such as articles; performing contraction expansion, including those with omitted apostrophes (such as “haven't”); abstracting urls, phone numbers, dates, addresses, and names associated with the filtered phrases, so that the canonical form reads just “Call me at PHONE-NUMBER” instead of “Call me at 212-555-1234”; aliasing i.e. converting several different ways of expressing the same sentiment into a single common form, so that splintered data can be aggregated (“I would like to”, “I want to”), many ways to say “please” such as “If you get a chance, would you.” or “would you be so kind as to . . . ”; and removing direct quotations embedded within the filtered phrases. By applying these processes the canonicalizer unit 205 generates canonicalized phrases.

As shown in FIG. 2, the filter module 105 may include a feature extractor unit 206 for receiving the canonicalized phrases generated by the canonicalizer unit 205 and for converting canonicalized phrases into a feature vector. The feature extractor unit 206 determines the length of canonicalized phrases and, for example, sees if (a) “Please” is first word of phrase; (b) “Please” is in the phrase, but not the first word; (c) if the phrase starts with an interrogative word (e.g. Which, where, what, how, why); (d) phrase starts with a 2nd person verb (e.g., “Put”, “Send”, “Pick”, “Go”) or other specific keywords or tokens such as URL's or phone numbers. The words in the canonicalized phrase may also be converted into n-grams that are extracted as features if they appear in a dictionary of sufficiently common word combinations in the native language.

As shown in FIG. 2, a classifier unit 207 receives the feature vectors generated by the feature extractor unit 206. The classifier unit 207 may be configured using one or more of a variety of classification techniques to determine actionable content from the received feature vectors. One preferred approach to configuring the classifier unit 207 is to apply supervised machine learning techniques to train the classifier on known positive instances (phrases requiring a recipient's attention, response, or action) and negative instances (sample phrases not requiring a recipient's attention, response, or action). The classifier unit 207 may include, but is not limited to, a Naive Bayes Classifier. Each feature in the feature vector is considered in turn with respect to each label (“actionable”, “not actionable”). The predictive power for the presence of that feature is the logarithm of the ratio of instances having both that feature and the label to those instances that have just the label. The scores of all of the features are summed and if the sum for the features deemed “actionable” minus the sum of the same features in the “not actionable” context exceeds a threshold value set during the training phase, the phrase is classified as one requiring user attention, response, or action.

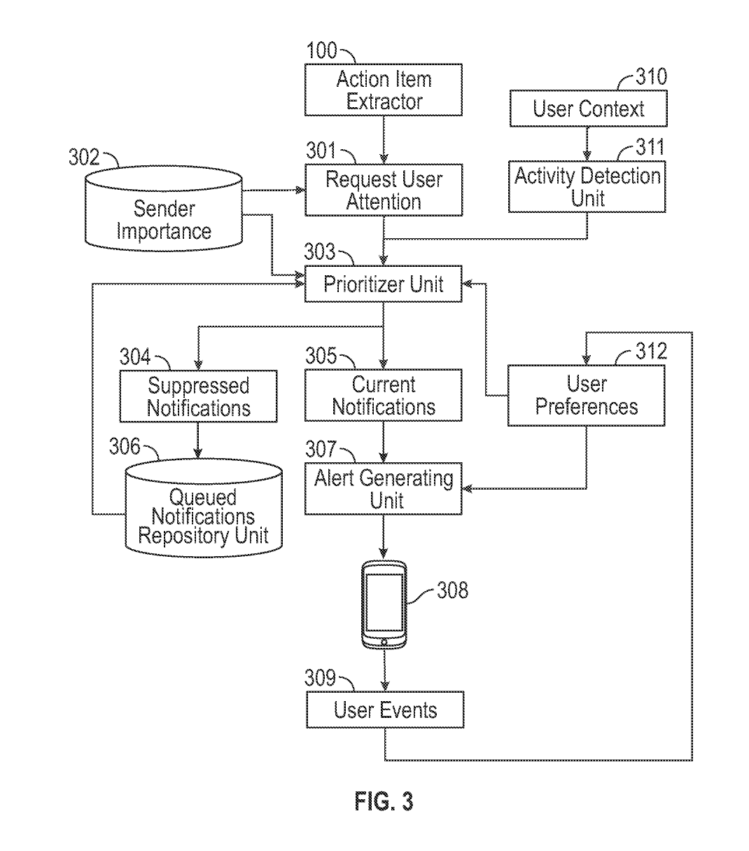

Referring to FIG. 3 is a diagram 300 depicting a system for displaying current notifications on the data communication device, in accordance with exemplary embodiments of the present disclosure. The notifications may be presented to the user based on a current user context 310 and user preferences 312, and the output of the system for automatically mining corpora of communications and identifying messages or phrases which require the recipient's attention, response, or action 100.

As shown in FIG. 3, a system for automatically mining corpora of communications and identifying messages or phrases which require the recipient's attention, response, or action 100 (as shown in FIG. 1) determines which parts of the incoming messages are candidates for being displayed as a current notification on the user's device.

As shown in FIG. 3, an activity detection unit 311 may be configured for collecting user context information 310 that may include, but is not limited to, sensor data from the user's communication or other wearable (smart watch, eye piece display, or other personal computing device with limited screen display) or implanted computing devices, or sensors in the user's vehicle, residence, or office that may be available to the system. These sensors may provide location, speed of travel, lighting conditions, ambient sound, etc. and calendar information (current location information, number and identities of other people present at the location, and scheduled activity). The user preferences 312 may be used for determining how or whether a user would like to receive a notification based on an inferred user activity. For example, a user who is in a meeting might wish to be informed via a vibration and short text message, whereas a user who is driving might prefer an audio summary. A user who is at an office may prefer to see the full text of the message with visual highlighting (e.g., black text on a yellow background) call attention to the phrases in the message requiring the recipient's attention, response, or action 100. A user who is away from the office due to travel may want the discovered items to be forwarded via email to his or her assistant or other delegate to be handled in the user's absence.

As shown in FIG. 3, the importance of each sender is recovered from the sender importance unit 302 The combination of the output of the system for automatically mining corpora of communications and identifying messages or phrases which require the recipient's attention, response, or action 100. and the importance of the sender 302, determines whether this particular message merits the user's attention. If it does, a request for user attention 301 is generated. The prioritizing unit 303 processes the request for user attention 301, and information pertaining to the user's availability that is used to generate current notifications 305 and suppressed notifications 304. The prioritizing unit 303 may also be configured for receiving queued notifications and storing them in a queued notifications repository unit 306.

As shown in FIG. 3, an alert generating unit 307 receives the current notifications generated by the prioritizing unit 303 and displays the current notifications on the user interface of the data communication device 308 of the user. The user's response to that notification is one or more user events 309 which may update the user preferences 312.

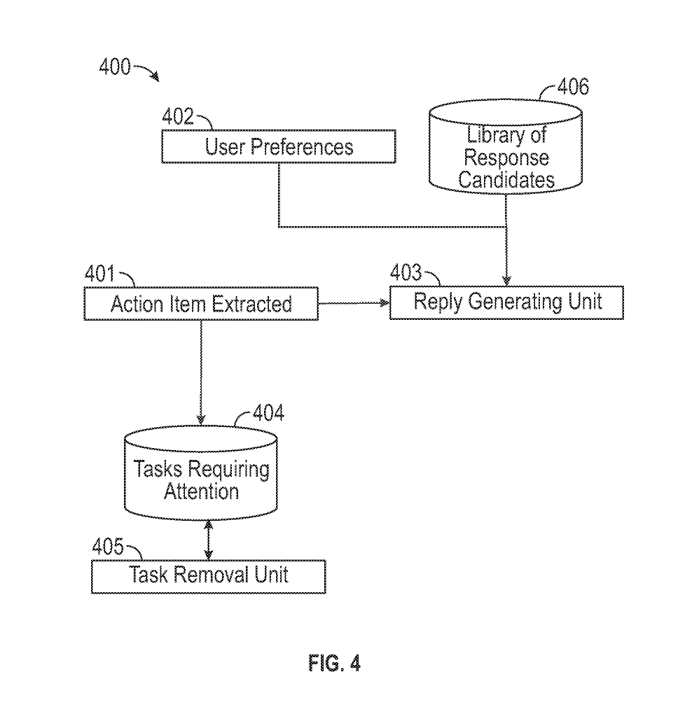

Referring to FIG. 4 is a diagram 400 depicting a system for assisting a user in responding to or handling action items and tracking completion status.

As shown in FIG. 4, a reply generating unit 403 may be configured to generate possible replies to the action item based on the content of the action item 401, past replies of the user, user preferences 402 and the like.

As shown in FIG. 4, the system may include a representation of tasks that may require the user's attention 404, e.g., a “Tasks Requiring Attention”. The representation of tasks that require attention includes each of the items that requires a user's action, along with the person requesting the action and the date by that it must be accomplished (the deadline) if mentioned. The task removal unit 405 may be configured to manage removal of tasks from that list automatically, based on specific user actions or system inferences. Example user actions include:
a) The user makes a non-trivial response to the message
b) The user explicitly checks off the item
c) The user communicates with the originator of the item by a different medium (e.g., send an SMS in reply to an email)
d) The user travels to a location where the task could be completed
   The system might infer that an item can be removed if:
a) The message contains a deadline (e.g., “Please RSVP before Tuesday if you plan to attend.”) which has already passed.
b) The user has established a default deadline (e.g., 48 hours from receipt of the message) that has already passed.

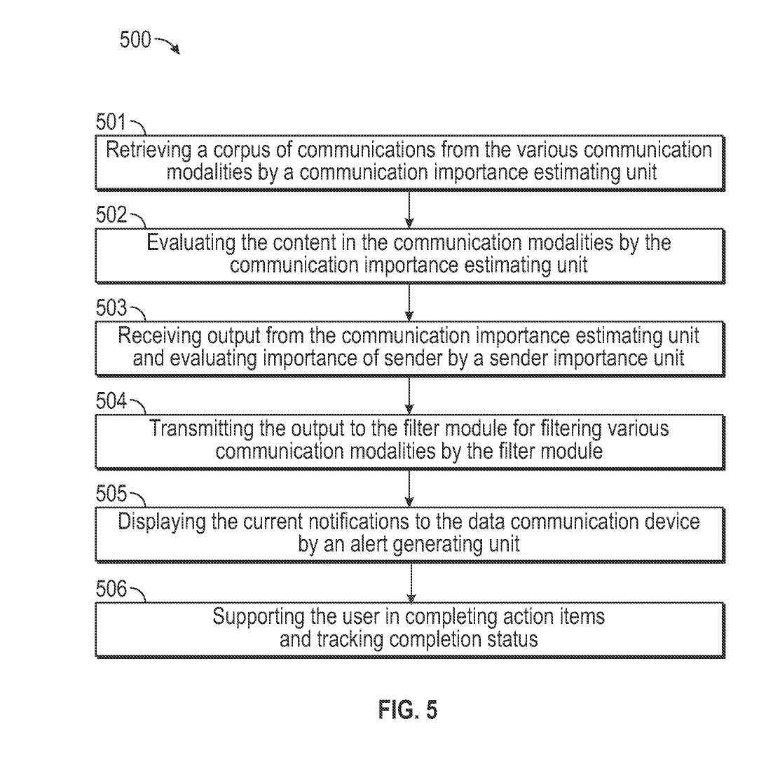

Referring to FIG. 5 is a flow diagram 500 depicting a method for automatically mining a corpus of communications and identifying actions, in accordance with exemplary embodiments of the present disclosure. The method starts at step 501, a communication importance-estimating unit configured to retrieve a corpus of communications from various communication modalities. The content of the various communication modalities may be evaluated by the communication importance-estimating unit at step 502. At step 503, a sender importance unit is configured to process the output received from the communication importance-estimating unit. The received output is transmitted to the filter module (as described in FIG. 2) for filtering the various communication modalities at step 504. Further at step 505, alerts may be displayed on the user interface of the data communication device based on the filtering by an alert generating unit. At step 506, assistance is provided to the user to reply or handle action items and to track pending or completion status of action items, including addition to the user's representation of tasks that require attention, if appropriate.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

1. A system for processing communications that detects just the portions of the communication requesting action, a response, or increased attention from a user, wherein said system comprises:
a. A message filter unit that analyzes the content and metadata of messages conveyed by various communication modalities and determines which portions of the messages request action, a response, or increased attention from the user.
b. A sender importance unit that determines from past communication patterns the perceived urgency that the user will afford to a new message from a particular sender; and
c. A user interface unit that alerts the user to detected items that require attention, response or action.

2. The system of claim 1, wherein the message filter is configured to perform one or more of the following steps:
a. Removal of signatures associated with the communication;
b. Bypass excerpts of replies; and forwarded communications contained within the communication;
c. Segmentation of a message into distinct phrases for individual analysis;
d. Removal of phrases that are rhetorical questions or social niceties where a response is not expected;
e. Removal of messages based upon metadata indicating the message is spam, marketing, or of interest to a general list of people;
f. Conversion of different representations into a common, canonical form, including one or more of:
i. Contraction expansion;
ii. Proper noun, URL, email address, phone number, and/or quantity abstraction;
iii. Aliasing of related vocabulary or concepts to an underlying abstract class;
iv. Removal of stop words;
and
g. Application of classification techniques to determine whether the analyzed content contains any of an action item, statement requiring added user attention, or question requiring user response.

3. The system of claim 1, wherein the user interface unit makes its user alerts dependent upon one or more of the following:
a. Current user activity as inferred from sensors associated with the user, including (without limitation) those in a communication device, those in a vehicle, those in a residence, or those worn on or implanted in the user's body;
b. Current user activity as inferred from the user's calendar;
c. User preferences; and
d. The number and identity of people present.

4. The system of claim 3 wherein the user interface unit is able to provide either highlighted text summaries or audio summaries; and the user interface unit is able to queue notifications that arrive at an inconvenient time until the user is able to attend to them.

5. The system of claim 1, wherein the user interface unit manages a representation of tasks that require attention for the user, entering action items as they are detected, and removing them based upon conditions defined by user action or system inferences.

6. The system of claim 1, wherein the user interface unit assists the user with making a reply by offering dynamic canned responses chosen from a library of candidate responses which is optionally filtered and customized based on the grammar and context of the item requiring a response.

7. The system of claim 1, wherein the user interface unit provides relevant templates that may be modified before sending, along with a virtual keyboard where each button corresponds to a word or phrase that is relevant as a potential response for the item requiring a response.

8. The system of claim 2, wherein the classification techniques consist of rule-based techniques that are triggered based on the content of the message, the identity of the sender, and/or metadata associated with the message.

9. The system of claim 2, wherein the classification techniques consist of applying supervised machine learning techniques to a feature vector based on one or more of the following feature types:
a. N-grams;
b. Phrase length;
c. Presence of dates, times, currency, names, or addresses;
d. Verb tense and form;
e. Politeness indicators, such as “Please” or “Would you”;
f. Punctuation markers; and
g. Initial interrogatives.

10. The system of claim 7, wherein the presentation and selection of response templates takes place on a wearable computing device.

11. A method for analyzing incoming communication messages to extract action items, questions requiring a user response, or information requiring additional user attention, comprising:
Retrieving messages from various communication media,
Optionally filtering messages based on metadata, such as the recipient's relationship with the sender or message header fields,
Segmenting communication messages into separate phrases,
Optionally generating a canonical form by abstracting irrelevant detail;
Extracting key features from each phrase, and
Applying classification techniques are to rate the probability that those phrases require an action, increased attention, or response from the user.

12. The method of claim 11, where the specific classification techniques are based on supervised learning, wherein a corpus of expert-labeled training instances are first analyzed to determine the predictive power of each feature, and subsequent incoming communication messages are tested for the presence of those features, with the said feature values being combined to rate the probability that those messages or constituent phrases also require an action, additional attention, or response from the user.

13. A method for presenting action items extracted from incoming communications, comprising at least one of: visual highlighting of extracted action ite99m(s); audio summary of extracted action item(s); entry of extracted action item onto user's representation of tasks that require attention; and forwarding the text of the action item in a selected communication medium to the user or his or her delegate.

14. A method for managing a user's electronic representation of tasks that require attention automatically, where incoming messages (for example, email, SMS, voice mail, social media) are scanned, action items extracted and added to the list.

15. A method for managing a user's electronic representation of tasks that require attention automatically, where items are removed from the list when particular actions are taken by the user, including, without limitation, the user's responding to the message, the user's responding to the sender through a different medium, the user's traveling to a place where the action item could be completed, a designated amount of time passing without action, or a deadline referenced in the message passing.

16. A method for expediting responses to requests for action that a user receives through incoming messages (for example, email, SMS, voice mail, social media), where pre-written responses are dynamically chosen from a library based on their relevance to the structure of the incoming message and dynamically adapted based on the grammatical structure of the request as well as contextual fillers for times or locations.

17. The method in claim 16 wherein the user can generate a new response using a virtual keyboard where keys represent words or full phrases the system deems relevant to the response.

18. The method of claim 16, comprising a step of presenting the extracted action items at a convenient time by a user, wherein such determination is made based upon the user's context with information drawn from one or more of: the user's calendar; current location; current activity as inferred by data from sensors in the user's personal communication devices, residence, vehicle, worn on or implanted in the body; other parties present in the room; and/or the user's explicitly stated preferences or those implicitly learned by the system over time.

19. The method of claim 16, comprising a step of finding the user's past responses and templates relevant to the request which the user can then edit or send as is.

20. The method of claim 15, comprising a step of prioritizing the order of presentation of action items by at least one of: importance of sender; stated urgency of request; and received time request.
